(19) United States
(12) Patent Application Publication
(10) Pub. No.: US 2009/0217708 A1
(43) Pub. Date: Sep. 3, 2009

(54) METHODS AND APPARATUS FOR REDUCING PLATINUM-GROUP DEFECTS IN SHEET GLASS

(76) Inventors: Gilbert DeAngelis, Lindley, NY (US); Aaron J. Hade, Corning, NY (US); Suzanne Karajaberlian, Toronto (CA); David M. Lineman, Painted Post, NY (US); William B. Mattingly, III, Painted Post, NY (US); Matthew C. Morse, Campbell, NY (US); Steven R. Moshier, Horseheads, NY (US)

Correspondence Address: CORNING INCORPORATED, SP-TI-3-1, CORNING, NY, 14831, US

(21) Appl. No.: 12/265,807

(22) Filed: Nov. 6, 2008

Related U.S. Application Data
(60) Provisional application No. 61/067,562, filed on Feb. 29, 2008.

(51) Int. Cl. C03B 32/00; C03B 5/16

(52) U.S. Cl. 65/134.2; 65/157

(57) ABSTRACT

A substantially-isolated/controlled, limited-volume, gas-filled space (e.g., 113b) is formed over at least one free (open) surface of flowing molten glass in a manufacturing line used to produce glass sheets (137), e.g., a manufacturing line employing the fusion process to produce glass sheets suitable for use as substrates for liquid crystal displays. At least a portion of the space comprises a platinum-group metal, e.g., a platinum-rhodium alloy, which can serve as a source of platinum-group condensate defects. The use of the substantially-isolated/controlled, limited-volume, gas-filled space substantially reduces the level of such platinum-group condensate defects in the glass sheets, e.g., by more than 50%.

### I. CLAIMING BENEFIT OF PRIOR FILED U.S. APPLICATION

This application claims the benefit of U.S. Provisional Application Ser. No. 61/067,562, filed on Feb. 29, 2008. The content of this document and the entire disclosure of publications, patents, and patent documents mentioned herein are incorporated by reference.

### II. FIELD OF THE INVENTION

This invention relates to the manufacture of sheet glass and, in particular, to methods and apparatus for reducing the level of platinum-group defects in sheet glass. Although the invention can be used in the manufacture of various types of sheet glass, it is especially advantageous in the production of large glass sheets for use as substrates in the production of displays, such as liquid crystal displays (LCDs), where the requirement for low defect levels is particularly stringent.

### III. BACKGROUND OF THE INVENTION

Sheet glass is produced by various techniques known in the art, including float processes and downdraw processes, such as the overflow downdraw process also known as the fusion process. In all of these processes, flowing molten glass is formed into a continuous glass ribbon which is separated into individual glass sheets.

For glasses having high melting temperatures, such as those used to produce LCD substrates, at least some of the melting, fining, stirring, conditioning, delivery, and forming equipment is made of materials comprising platinum-group metals, with platinum and platinum alloys, e.g., platinum-rhodium alloys, being the most commonly used materials. (As used herein, the platinum-group metals are platinum, rhodium, palladium, iridium, rhenium, ruthenium, and osmium.)

The presence of platinum-containing defects has been a long standing problem in the production of LCD glass substrates. Commonly-assigned U.S. Pat. No. 7,127,919 discusses one source of such defects, namely, erosion of platinum-containing components (e.g., stirrers and stir chamber walls) used in homogenizing molten glass. The '919 patent provides methods and apparatus for substantially reducing the level of defects arising from this source without compromising the homogeneity of the finished glass substrates.

The present invention addresses another source of platinum-group defects, namely, the formation of condensates of platinum-group metals, e.g., platinum, at locations in the manufacturing process at which there is a free (open) surface of flowing molten glass. Commonly-assigned U.S. Patent Application Publication No. US 2006/0042318 discloses one approach for addressing the condensate problem. In the '318 publication, a flow of gas, e.g., air, along the shaft of a stirrer used in homogenizing a glass melt is employed to reduce the formation of platinum-containing condensates on the shaft.

The present invention involves an alternate approach to the condensate problem which has surprisingly been found to markedly reduce the number of condensate-based, platinum-group defects found in glass sheets. FIG. 12, which is discussed more fully below, shows the results of an experimental study which employed an embodiment of the invention (see region after the vertical bar). As can be seen in this figure, the invention operated essentially as a switch for turning off (reducing) the formation of these types of defects.

### IV. SUMMARY OF THE INVENTION

In accordance with a first aspect, the invention provides a method for reducing the level of platinum-group condensate defects in glass sheets produced by a process in which flowing molten glass has a free surface (open surface) that is located at or below a structure that comprises a platinum-group metal that can serve as a source of said defects, said method comprising:

(a) providing a limited-volume, gas-filled space which is in contact with said free surface and said structure; and

(b) substantially controlling the environment within the space and substantially isolating the space from the surrounding environment so that the average level of platinum-group condensate defects in the glass sheets produced by the process is less than or equal to 0.02 defects/kilogram.

In accordance with a second aspect, the invention provides a method for reducing the level of platinum-group condensate defects in glass sheets produced by a process in which flowing molten glass has a free surface (open surface) that is located at or below a structure that comprises a platinum-group metal that can serve as a source of said defects, said method comprising:

(a) providing a limited-volume, gas-filled space which is in contact with said free surface and said structure; and

(b) substantially controlling the environment within the space and substantially isolating the space from the surrounding environment so as to produce an average level of platinum-group condensate defects in the glass sheets produced by the process that is at least 50% less than the average level of platinum-group condensate defects in glass sheets produced by the same process but without the substantial control and isolation.

In certain embodiments of the first and second aspects of the invention, the space is filled with a gas whose average oxygen content is less than or equal to 10 volume percent.

In accordance with a third aspect, the invention provides apparatus comprising:

(a) an enclosure over a free surface (open surface) of flowing molten glass, said enclosure having a limited internal volume, said volume being in contact with a material which comprises a platinum-group metal;

(b) at least one heat source which provides heat to the enclosure; and

(c) at least one inlet through which gas of a defined composition is introduced into the enclosure at a selected rate;

wherein:

(i) the maximum temperature difference between any two points within the enclosure is less than or equal to 250° C.; and

(ii) the selected rate results in a gas exchange time for the enclosure which is greater than 3 minutes.

In accordance with a fourth aspect, the invention provides a population of 100 sequential glass sheets produced by a glass sheet manufacturing process wherein: (i) each sheet has a volume of at least 1,800 cubic centimeters (e.g., the sheets are large enough to produce Gen 6 LCD substrates), preferably, a volume of at least 3,500 cubic centimeters (e.g., the sheets are large enough to produce Gen 8 LCD substrates), and (ii) the level of platinum-group condensate defects for the population is less than or equal to 0.02 defects/kilogram.

Additional features and advantages of the invention are set forth in the detailed description which follows, and in part will be readily apparent to those skilled in the art from that description or recognized by practicing the invention as described herein. It is to be understood that the specific embodiments described herein are merely exemplary of the invention and are intended to provide an overview or framework for understanding the nature and character of the invention without limiting its scope.

The accompanying drawings are included to provide a further understanding of the invention, and are incorporated in and constitute a part of this specification. It is to be understood that the various features of the invention disclosed in this specification and in the drawings can be used in any and all combinations.

### V. BRIEF DESCRIPTION OF THE DRAWINGS

FIG. 1 is a plot of mass loss of platinum (vertical axis) versus oxygen partial pressure (horizontal axis) for four temperatures ranging from 1200° C. (lowest curve) to 1550° C. (upper curve).

FIG. 2 is a plot of mass loss of platinum (vertical axis) versus temperature (horizontal axis) for two oxygen levels (10% lower curve; 20% upper curve).

FIG. 3 is a plot of mass loss of platinum (vertical axis) versus gas flow (horizontal axis) for two temperatures (1550° C. lower curve; 1645° C. upper curve).

FIG. 4 is a plot of total pressure for each of the platinum-group metals platinum and rhodium (vertical axis) versus temperature (horizontal axis) for three different oxygen concentrations.

FIGS. 5 and 6 are plots of computed convective flows in a limited-volume, gas-filled space which contacts a free surface of molten glass of a stir chamber with (FIG. 6) and without (FIG. 5) substantial isolation/control of the space.

FIG. 7 is a schematic diagram illustrating representative applications of embodiments of the invention to free surfaces of flowing molten glass in a fusion process for producing glass sheets.

FIG. 8 is a perspective view of equipment that can be used in producing a substantially-isolated/controlled, limited-volume, gas-filled space at and above the free surface of molten glass passing through a stir chamber.

FIG. 9 is a perspective view of the equipment within circle 310 of FIG. 8.

FIG. 10 shows the equipment of FIG. 9 with its front section removed.

FIG. 11 is an exploded view of the front and rear sections of the equipment of FIG. 9.

FIG. 12 is a time series plot showing platinum defects per pound in glass sheets produced using a fusion process before and after the application of substantial isolation/control of the space at and above the free surface of glass flowing through a stir chamber, where the application of substantial isolation/control is shown by the shaded vertical bar in the figure.

### VI. DETAILED DESCRIPTION OF THE INVENTION AND ITS PREFERRED EMBODIMENTS

As discussed above, the present invention relates to the problem of platinum-group defects in sheet glass. More particularly, it relates to the formation of condensates of platinum-group metals at locations in the manufacturing process at which flowing molten glass has a free surface and one or more exposed surfaces comprising a platinum-group metal, e.g., platinum or a platinum alloy, are located at or above the free surface. (As used herein, the phrase “at or above” when applied to the spatial relationship between a structure or surface which comprises a platinum-group metal and a free surface of flowing molten glass includes a structure or surface which is both at and above the free surface. Similarly the phrase “at or below” used for the same purpose includes the case where a free surface of flowing molten glass is both at and below a structure or surface which comprises a platinum-group metal.)

Because of the high temperatures involved, at certain locations at or above the free surface, platinum-group metals can undergo oxidization to form a vapor of the metal (e.g., a PtO₂ vapor) which can revert to the metal and condense into metal particles at other locations at or above the free surface. These platinum-group metal particles can then “rain” back onto the free surface or be entrained in the glass flow and thereby form defects (typically, inclusions) in the finished glass sheets.

Defects comprising a platinum-group metal formed by this mechanism (referred to herein as “platinum-group condensate defects” or simply “condensate defects”) have characteristics that distinguish them from defects comprising a platinum-group metal formed by other mechanisms. Thus, condensate defects are crystalline shaped and their largest dimensions are equal to or greater than 50 microns.

Platinum-group condensate defects originate from the following chemical and thermodynamic effects. The primary source of the problem is a range of 2-way reactions which platinum-group metals can enter into with oxygen. For example, for platinum and rhodium, one of the 2-way reactions can be written:

Pt(s)+O₂(g) [symbol] PtO₂ (1)

4Rh(s)+3O₂(g) [symbol] 2Rh₂O₃ (2)

Other reactions involving platinum can generate PtO and other oxides, and other reactions involving rhodium can generate RhO, RhO₂, and other oxides.

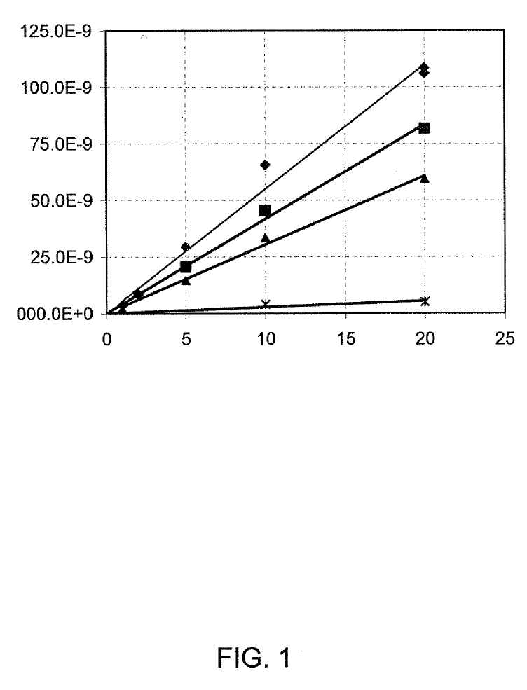

The forward direction of these reactions can be considered as the “originating source” (starting point) for platinum-group condensate defects. As illustrated in FIGS. 1-3, primary factors that influence the forward rate of these reactions are pO₂, temperature, and flow velocity.

In particular, FIG. 1 shows the effect of pO₂ on the forward reaction of platinum for four different temperatures, i.e., 1200° C.—star data points; 1450° C.—triangular data points; 1500° C.—square data points; and 1550° C.—diamond data points. The horizontal axis in this figure is oxygen partial pressure in %, while the vertical axis is mass loss of platinum in grams/cm²/second. The straight lines are linear fits to the experimental data. As can be seen in FIG. 1, the oxidization and vaporization of platinum increases substantially linearly with oxygen partial pressure, with the slope of the effect becoming ever greater as the temperature increases.

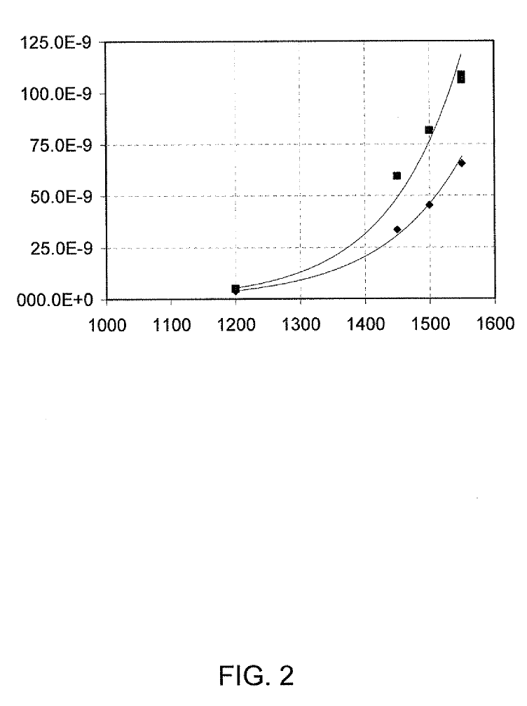

FIG. 2 shows the temperature effect in more detail. The horizontal axis in this figure is temperature in ° C., while the vertical axis is again mass loss of platinum in grams/cm²/second. The diamond data points are for an atmosphere having an oxygen partial pressure of 10%, while the square data points are for an oxygen partial pressure of 20%. The curves through the data points are exponential fits. The rapid (exponential) increase in platinum oxidization and vaporization with an increase in temperature is evident from this data. Although not shown in FIG. 2, other experiments have shown that the onset of Pt volatilization is ˜600° C.

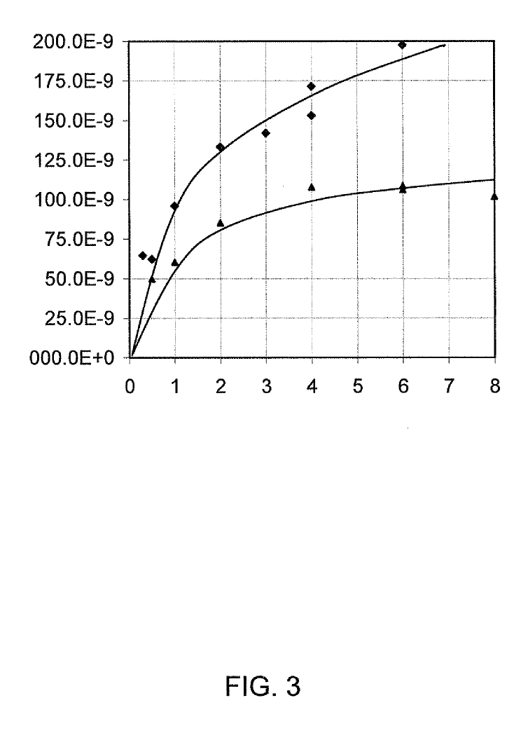

FIG. 3 shows the effects of the third major parameter involved in the oxidation and vaporization of platinum-group metals, i.e., flow rate of an oxygen containing atmosphere over the surface of the metal. The horizontal axis in this figure is flow rate in standard liters per minute (SLPM) through the vessel in which the platinum sample was housed for the test, while as in FIG. 1 and FIG. 2, the vertical axis is mass loss of platinum in grams/cm²/second. The triangular data points are for a temperature of 1550° C., while the diamond data points were obtained at 1645° C. The oxygen partial pressure in both cases was 20%.

As can be seen in FIG. 3, the mass loss of platinum increases rapidly for both temperatures as one moves away from the stagnant condition and then tends to level off somewhat, especially at lower temperatures, as the flow rate increases. Although not wishing to be bound by any particular theory of operation, it is believed that a flow increase at exposed metal surfaces strips the oxide layer at the metal-gas interface and promotes more rapid oxidation. Flow is also believed to inhibit the establishment of an equilibrium vapor pressure of oxide over the metal surface which would kinetically reduce the rate of volatile specie generation.

Considering FIGS. 1-3 as a group, it can be seen that the originating source of platinum-group condensate defects, i.e., oxidation and vaporization of the platinum-group metal, increases with each of pO₂, temperature, and flow rate, with the combined effects being substantially additive. Thus, the originating source for condensate defects can be viewed as those areas of structures in the vicinity of a free surface of flowing molten glass where materials comprising a platinum-group metal are exposed to higher oxygen concentrations, higher temperatures, and/or higher flow rates than at other areas, the combination of two or all three of these conditions being the most offending (most troublesome) originating sources.

Oxidation/vaporization of platinum-group metals in and of itself does not lead to condensate defects. Rather, there needs to be a condensation of solids from the vapor/gaseous atmosphere over a free surface of flowing molten glass to produce particles which can “rain” down on the free surface or otherwise become entrained in the flowing glass and thus become condensate defects in the glass sheets. The backward reactions of the governing equations (1) and (2) above promote condensation of the platinum-group metals and thus can be thought of as the “sink” for solid particle formation.

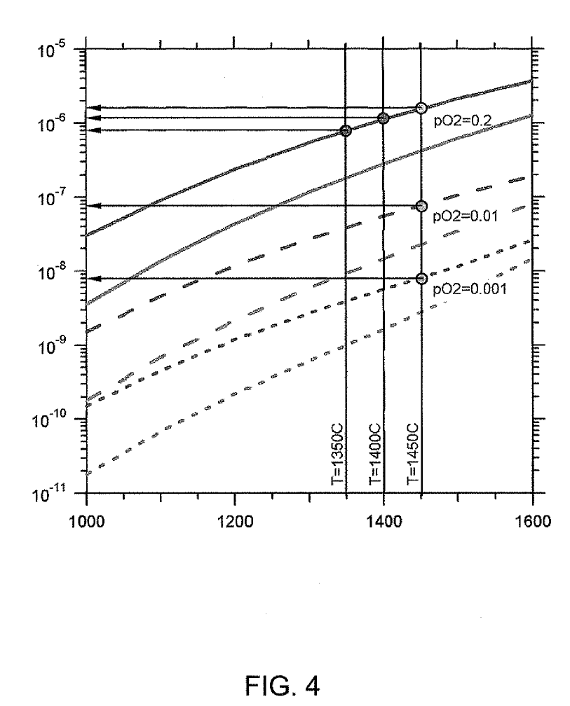

Factors responsible for accelerating the rate of the backward reactions include drops in temperature and/or pO₂. FIG. 4 illustrates the thermodynamics involved in the condensation process. The horizontal axis in this figure is temperature in ° C., while the vertical axis is total pressure in atmospheres of gaseous species containing the platinum-group metal. The thermodynamic calculations shown in this figure are for an 80 wt. % platinum-20 wt. % rhodium alloy. The pairs of (i) solid lines, (ii) dashed lines, and (iii) dotted lines denote atmospheres with pO₂ values of 0.2 atm, 0.01 atm, and 0.001 atm, respectively. For each pair of lines, the upper member of the pair represents platinum and the lower rhodium.

As can be seen in this figure, as platinum and/or rhodium vapors created in a high temperature area move into a colder region, they become unstable, resulting in condensation of solid particles of the parent metal. The three circled points at the top of the figure show this effect for platinum in an atmosphere having a pO₂ value of 0.2 atmospheres. As can be seen from these points, as the temperature drops from 1450° C. to 1350° C., the total pressure of platinum-containing species in the atmosphere must drop from about 0.5×10⁻⁶ atm to about 0.8×10⁻⁷ atm. The mechanism for this drop in gaseous pressure of platinum-containing species is condensation, i.e., transformation from the gaseous state to the solid state.

FIG. 4 also shows that as platinum and/or rhodium vapors created in a highly oxidized area move into an area with a lower oxygen level, formation of solid specie will again occur. The three circled points along the T=1450° C. line illustrate this effect. As pO₂ drops from 0.2 atm (the uppermost of the three points) to 0.001 atm (the lowermost), the total pressure of platinum-containing species in the atmosphere must drop from about 0.5×10⁻⁶ atm to about 0.8×10⁻⁹ atm. Again, this drop means that a solid form of platinum must be formed. That solid form constitutes the metal condensate particles that can fall back into, or be entrained into, the molten glass stream and create metal specks in the solidified glass sheets.

As with the “source” portion of the defect generation process, gas flow also plays a role in the “sink” (condensation) portion. Although again not wishing to be bound by any particular theory of operation, it is believed that substantial flows inhibit the establishment of an equilibrium vapor pressure of oxide at those locations where solid particles are likely to form.

In accordance with the invention, the problem of platinum-group condensate defects is addressed by attacking both the source and sink sides of the problem. This is accomplished by providing a substantially-isolated/controlled, limited volume, gas-filled space which contacts (e.g., is bounded by and/or contains): (1) the free surface of the flowing molten glass, (2) the material or materials which comprise platinum-group metal(s) and serve as the originating source for the defects, and (3) the structure(s) at or above the free surface upon which condensates can be expected to form and thereafter “rain” down onto the free surface and/or be entrained into the flowing glass.

The space is filled with a gas, as opposed to being evacuated. The gas has a defined composition. In particular, the gas preferably has a low oxygen content. This not only reduces the source side of the defect generation process, but also the sink side through a reduction in the magnitudes of oxygen gradients with the space. As discussed below, the gas-filled space preferably has an oxygen content which is less than or equal to 10 vol. %, more preferably, less than or equal to 2 vol. %, and most preferably, less than or equal to 1 vol. %. The remainder of the gas can be composed of inert components, e.g., nitrogen or argon.

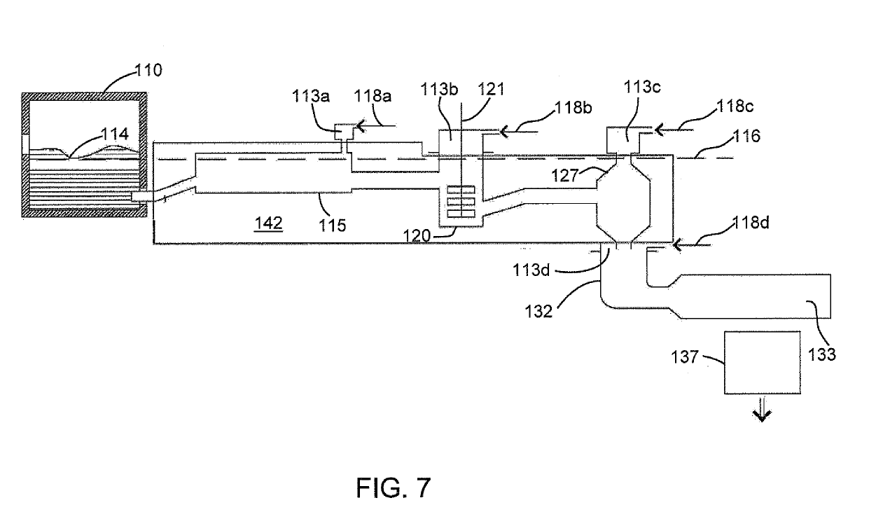

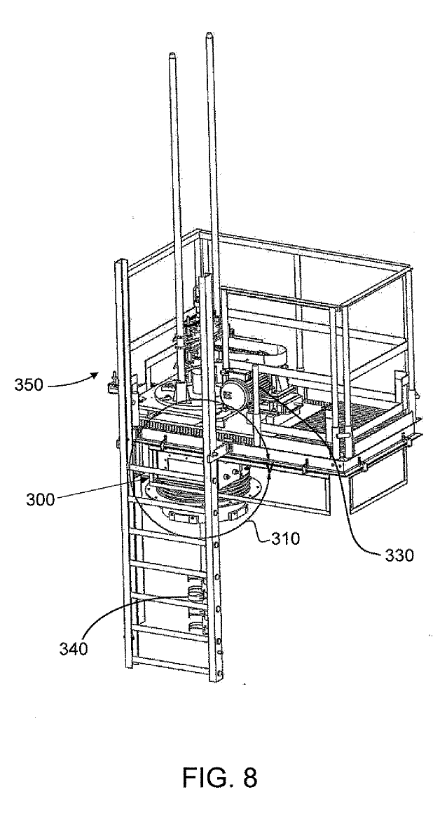

The gas-filled space has a limited volume in the sense that it is dedicated to isolating/controlling the space at and above a specific free surface of molten glass, as opposed to a larger portion of a glass manufacturing line (see, for example, space 142 of FIG. 7 discussed below). The volume will, of course, vary with the area of the free surface and thus, for example, will be larger for a finer than for a stir chamber. As a point of reference, the volume of the limited-volume, gas-filled space produced by the equipment shown in FIGS. 8-11 for a stir chamber was approximately 100 liters. In general terms, the volume of the limited-volume, gas-filled space will be in the range from approximately 50 liters on the low end to approximately 1000 liters on the high end. Preferably, the volume is less than 1000 liters, more preferably, less than 500 liters, and most preferably, less than or equal to 100 liters, since smaller volumes are easier to substantially isolate/control and the costs associated with incorporating smaller substantially isolated/controlled spaces in manufacturing lines are less.

The limited-volume, gas-filled space is “substantially-isolated/controlled” in the sense that its internal environment and its interaction with its surrounding environment are substantially determined by the user both in terms of material flows and heat flows. With regard to material flows, the substantial isolation/control allows the chemical composition of the limited-volume, gas-filled space to be determined by the user. In particular, it allows the average oxygen content in the space to be specified and controlled so as to address the role oxygen plays in both the source (see, for example, FIGS. 1 and 2) and sink (see, for example, FIG. 4) aspects of the defect generation process. In addition, the substantial isolation/control with regard to material flows allows the overall flow of gas through the space to be determined by the user to reduce the effects of gas flow in defect generation (see, for example, FIG. 3).

Because in a manufacturing setting it is difficult to prevent all flow into or out of a gas-filled space, e.g., it can be difficult to reduce all leaks to zero especially at the elevated temperatures associated with molten glass, the substantial-isolation/control with regard to material flows will often involve providing the limited-volume, gas-filled space with a pressure somewhat above that of its surrounding environment so that net flow is outward from the space, e.g., a positive differential pressure that is above zero and is at most 0.01 atmospheres, preferably, at most 0.001 atmospheres, and most preferably, at most 0.0001 atmospheres. This facilitates control of the chemical composition within the space since it avoids entry of gases from the surrounding environment whose composition may be uncontrolled and/or variable over time.

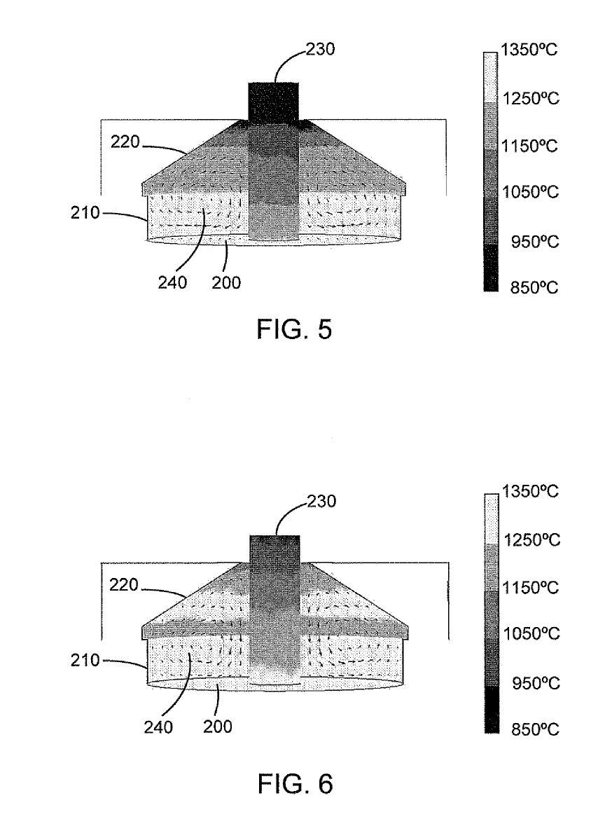

The pressure within the space and thus the net outward flow from the space is achieved by providing the space with one or more gas inlets for introducing gas having the desired chemical composition into the space. The location(s) of the inlet(s) is chosen to minimize flow at the typical source/sink trouble spots for condensate defect generation within the space. For example, as illustrated by the computer simulations of FIGS. 5 and 6 below, a typical source trouble spot is at or near the glass line where the temperatures of the wall portion of the gas-filled space's perimeter surface are highest and a typical sink trouble spot is near the top of the gas-filled space where the temperatures are lowest. Accordingly, the inlet(s) for introducing gas into the gas-filled space will typically avoid these locations.

In terms of heat flows, the limited-volume, gas-filled space is substantially isolated/controlled relative to its environment so that temperature gradients within the space can be reduced. In this way, the space can address the role that temperature differences plays in both the source (see, for example, FIGS. 1-3) and sink (see, for example, FIG. 4) aspects of the defect generation process. Moreover, because temperature gradients lead to convective gas flows (see FIGS. 5 and 6), control of temperature gradients also provides a mechanism for reducing localized and/or overall convective gas flows so as to reduce the effects of gas flow on defect formation (see, for example, FIG. 3).

Heat flow isolation/control will generally involve the use of thermal insulating materials around the limited-volume, gas-filled space, the placement of heat sources at selected locations, and the use of free or forced convection at the boundaries with the external environment. Typically, the heat sources will be located along or in the vicinity of the space's perimeter wall, but heat sources within the space can also be used if desired. The heat sources can be adjustable to allow the temperatures within the space to be controlled irrespective of temporal and/or spatial changes in the temperature distribution in the environment outside of the space. In addition to using insulation around the outside of the space, insulation can also be used inside the space to reduce internal temperature gradients. For example, in the case of a stir chamber, an intermediate cover can be used to divide the space into two regions having restricted gas communication. By insulating the cover, the temperature gradient in the region closest to the molten glass can be reduced.

The words “substantial” and “substantially” are used in connection with the isolation/control of the limited-volume, gas-filled space to denote that complete isolation/control is not needed but merely a practical and sufficient amount of isolation/control to achieve a level of platinum-group condensate defects which is acceptable for particular applications of the invention. For example, in the case of LCD substrates, the size requirements for substrates has increased over the years and the surface discontinuity requirements have been tightened. Since platinum-group condensate defects are a significant source of rejected substrates, in practice, a level of isolation/control of the limited-volume, gas-filled space will be used which provides an acceptably low level of rejects. Of course, from an economic point of view, the lower the level of rejects, the better, and thus in the end, the level of isolation/control used will depend on a cost/benefit analysis between the overall costs in achieving greater levels of isolation/control and the resulting benefits in terms of lower defect levels.

FIGS. 8-11 illustrate one type of equipment that can be used to achieve major drops in platinum-group condensate defects. This equipment employs commercially available materials and components and it or similar equipment can be readily produced by persons of ordinary skill in the art based on the present disclosure. The equipment achieves substantial, but not complete, isolation/control of a limited-volume, gas-filled space, in this case, the space at and above the free surface of molten glass passing through a stir chamber (see discussion below).

In view of the foregoing, the level of isolation/control can conveniently be expressed in terms of the level of platinum-group condensate defects in glass sheets produced using the invention. Preferably, the limited-volume, gas-filled space is isolated/controlled at a level such that use of the space reduces the average number of platinum-group condensate defects per unit weight of glass sheets by at least 50%, preferably, by at least 75%, and most preferably, by at least 90%. In terms of absolute levels of defects, the use of the substantially-isolated/controlled, limited-volume, gas-filled space (or spaces when more than one free surface of glass is equipped with such a space) preferably results in an average level of platinum-group condensate defects that is less than or equal to 0.01 defects/pound (0.02 defects/kilogram), more preferably, less than or equal to 0.005 defects/pound (0.01 defects/kilogram), and most preferably, less than or equal to 0.001 defects/pound (0.002 defects/kilogram).

The level of defects can also be expressed in terms of the defects per pound for a sequential series of glass sheets having a specified size produced by a glass sheet manufacturing process, e.g., a fusion process. This is a direct measure of the reject level of the manufacturing process and, as will be evident, is of great commercial significance. Through the use of the substantially-isolated/controlled, limited-volume, gas-filled space(s) of the invention, reject levels not previously known in the art have become achievable. In particular, a population of 100 sequential glass sheets, each having a volume of at least 1,800 cubic centimeters, can be manufactured with a level of platinum-group condensate defects for the population that is less than or equal to 0.01 defects/pound (0.02 defects/kilogram).

Depending on the application, the level of isolation/control of the limited-volume, gas-filled space can also be characterized in terms of: (i) the oxygen concentration within the gas-filled space, (ii) temperature differences within the gas-filled space, (iii) net flows of gases out of the space, and/or (iv) convective gas flows within the space.

The oxygen concentration in the space is particularly useful in characterizing the level of isolation/control of the limited-volume, gas-filled space for cases where local oxygen concentrations are close to the average oxygen concentration. As discussed below in connection with FIG. 7, for a fusion process, a substantially-isolated/controlled, limited-volume, gas-filled space can be formed over the free surfaces of molten glass that exist in the finer, the stir chamber, the bowl, and the delivery system-to-fusion machine transition. Of these locations, only the finer will typically exhibit large spatial variations in the local oxygen concentration, e.g., in the finer, the oxygen concentration at the surface of the molten glass will typically be higher than the oxygen concentrations elsewhere in the finer since the purpose of the finer is to remove gaseous inclusions, including gaseous inclusions containing oxygen, from the molten glass. For the other three locations, the oxygen concentration within the limited-volume, gas-filled space will be relatively uniform and thus its average value provides an effective measure of the level of isolation/control of these spaces for the purposes of this invention.

Quantitatively, the average oxygen content in the space is preferably less than or equal to 10 volume percent (i.e., less than the volume percentage of oxygen in air), more preferably, less than or equal to 2 volume percent, and most preferably, less than or equal to 1 volume percent. In addition to reducing condensate defects, lower oxygen levels may help in reducing gaseous inclusions by reducing the oxygen content in the glass which is known to cause shrinkage of oxygen-containing gaseous inclusions in molten glass.

The maximum temperature difference between any two points in the limited-volume, gas-filled space is another useful parameter for characterizing the level of isolation/control of the space. As discussed below in connection with FIGS. 5-6, the maximum temperature normally occurs in the vicinity of the junction between the wall of the space and the glass line, while the minimum temperature normally occurs near the top of the space, although other distributions are possible depending on the particular application of the invention.

The temperature distribution of a limited-volume, gas-filled space can be measured by, for example, placing thermocouples at various locations along the wall of the space. However, in practice, it has been found more practical and efficient to use computer modeling to estimate the temperature distribution and to confirm the computer modeling using a limited number of actual measurements, e.g., thermocouple measurements. This was the approach used for FIGS. 5-6 discussed below.

Whether determined by actual measurements or by modeling, the maximum temperature difference between any two points of the substantially-isolated/controlled, limited-volume, gas-filled space is preferably less than 250° C., more preferably, less than or equal to 125° C., and most preferably, less than or equal to 25° C.

The net flow of gas out of the limited-volume, gas-filled space is also a useful measure of the degree of isolation/control of the space. Quantitatively, the net flow can be characterized in terms of the gas exchange time for the space, i.e., the time required to achieve a full exchange of the volume of gas within the space. Preferably, the gas exchange time is greater than or equal to 3 minutes, more preferably, greater than or equal to 10 minutes, and most preferably, greater than or equal to 30 minutes.

In terms of convective flows, although it is possible to make gas flow measurements at different locations within the space, in practice, it is more economical and efficient to use computer modeling to calculate convective flows based on inputted data, e.g., molten glass temperatures, temperatures at selected locations of the modeled space, and net outflow of gas from the space, in combination with the known geometry of the space and the thermal properties of the materials bounding the space.

FIGS. 5-6 illustrate the modeling approach for a gas-filled space 240 whose bottom surface 200 is molten glass, whose side surfaces 210 are vertical, and whose top surface 220 is conically-shaped. For purposes of illustration, it has been assumed that a shaft 230 of a stirrer passes through the space. Such a shaft will be present for a gas-filled space at and above the free surface of a stir chamber (a particularly advantageous application of the invention; see below), but will not be present in general (see, for example, the discussion of FIG. 7 below).

The modeling is preferably performed using techniques of the type employed in computational fluid dynamics (CFD) calculations. In overview, in accordance with CFD, the geometry to be studied is specified and divided into, for example, a mesh of finite elements, boundary conditions and material properties are also specified, and then a numerical solution to the fluid dynamics equations is obtained for the specified geometry and the specified boundary conditions and material properties.

Each of these modeling steps can be performed using customized software or, preferably, with commercially available software packages, such as, for 3-D CAD: AUTOCAD, PRO/ENGINEER, or SOLIDWORKS; for meshing: GAMBIT OR ICEMCFD; and for calculating flows, temperatures, etc.: FLUENT, FLOW3-D, or ACUSOLVE. For example, the plots of FIGS. 5-6 were generated beginning with the 3-D CAD software package, SOLIDWORKS, which was used to specify the relevant geometry. The geometry was then exported to ICEMCFD software for meshing into finite elements. Models for systems of the type with which the present invention is concerned typically require 1-2 million elements. The finite element software ACUSOLVE was then used to generate a solution. This software uses the ICEMCFD mesh as well as material properties and boundary conditions as inputs, and through an iterative process, converges to a steady state solution. That solution includes temperature fields throughout all volumes, as well as pressures and velocities of the gas in the model. Other software packages besides SOLIDWORKS, ICEMCFD, and ACUSOLVE, such as those listed above, can, of course, be used in the practice of the invention if desired.

In the modeling of FIGS. 5-6, the top part of a vertical stir chamber was represented in three dimensions. The model included the molten glass, the stirrer shaft, and the insulation and heater locations of the physical equipment being modeled. A glass depth of, in this case, about 10.8 inches was used in the model geometry so that the bottom plane of the model corresponded to a location where temperature measurements were made during operation of the physical equipment. The base case model (FIG. 5) also included a volume of gas (air) above the stir chamber to fully capture convective phenomena. All gas movement was due to natural convection, i.e., no gas movement was specified in the model conditions. Such gas movement can, of course, be specified if desired.

The inputted material properties were as follows: for solids—thermal conductivity, density, and specific heat; for fluids (gases)—thermal conductivity, density, specific heat, and viscosity. For solid-gas interfaces, where there is heat transfer through radiation, a value for emissivity (dependent on the solid material) was also given. The molten glass was treated in the model as a solid, and its radiative properties were included in its thermal conductivity property via a Rosseland approximation.

The boundary conditions used were as follows. The temperatures of the glass and of the stirrer shaft at the bottom of the model were set to match the measured value at this location for the physical equipment. Heater powers were also set to those of the physical equipment. External conditions define how heat can leave the model. These conditions are not identical everywhere, but depend on what surrounds the various parts of the physical equipment. The chief differences are whether there is free or forced convection on the boundary, and the ambient temperature near it. Based on the known configuration and environment of the physical equipment, these heat loss conditions were also specified in the model.

The results are shown graphically in FIGS. 5-6. As can be seen in these figures, the temperature differences in space 240 are smaller when substantial isolation/control is used (FIG. 6) than when it is not used (FIG. 5). Quantitatively, the calculated temperatures along the free surface of the glass for the FIG. 5 case varied between 1285° C. at the stirrer shaft to 1305° C. at the junction of the glass with the stir chamber's vertical wall. For the FIG. 6 case, the range was 1302° C. to 1321° C. Going up the vertical wall, the calculated temperatures varied from 1304° C. just above the junction with the glass to 1208° C. at the top of the wall for FIG. 5 (i.e., a difference of 96° C.), while for FIG. 6, i.e., with substantial isolation and control, the corresponding values were 1321° C. and 1247° C. (i.e., a temperature difference along the wall of only 74° C.).

In both cases, the maximum temperature within the space was at the junction between the glass and the vertical wall (1305° C. for FIG. 5 and 1321° C. for FIG. 6) and the minimum temperature was at the top of the space where the stirrer rod exited the space (992° C. for FIG. 5 and 1102° C. for FIG. 6). The maximum temperature difference within the space for the two cases was thus 313° C. for FIG. 5, but only 219° C. for FIG. 6. This reduced temperature difference achieved through substantial isolation and control of the internal space not only addresses the source and sink aspects of condensate formation, but also reduces gas flow within the space as evidenced by a maximum calculated convective linear velocity of 10.6 cm/sec for FIG. 6 compared to 16.5 cm/sec for FIG. 5. In each case, the maximum velocity occurred along the stirrer shaft.

Using the calculated maximum internal temperatures and calculated maximum convective linear velocities for FIGS. 5-6, an estimate can be made of platinum/rhodium mass loss rates, e.g., by using the data of FIGS. 1-3. For oxygen partial pressures which are the same, the lower linear velocity of FIG. 6 compared to FIG. 5 is offset by the higher maximum temperature, so that the mass loss rates are basically the same. However, by adding the additional variable of controlling the oxygen content in the space, a significant difference in mass loss rates is found. Thus, the calculated mass loss rate for the FIG. 5 data and an oxygen partial pressure of 21% (air) is 7.8×10⁻⁹ grams/cm²/second, while for the FIG. 6 data and an oxygen partial pressure of 1%, it is 3.4×10⁻¹⁰ grams/cm²/second, a reduction of over 95%.

Using computer modeling of the foregoing type, substantial control of convective flows within a limited-volume, gas-filled space can be quantified in terms of the gas' maximum calculated convective linear velocity within the space. Preferably, that velocity is less than or equal to 15 centimeters/second, more preferably, less than or equal to 10 centimeters/second, and most preferably less than or equal to 5 centimeters/second. The convective flows can also be characterized by their overall calculated flowrate values determined by taking a cross-section through the limited-volume, gas-filled space and calculating the flow across that cross-section per unit time. For this measure, substantial control of the convective flow within the limited volume, gas-filled space corresponds to a flowrate that preferably is less than or equal to 1.0 SCFM (5.28 ft³/min; 2,500 cm³/sec), more preferably, less than or equal to 0.5 SCFM (2.64 ft³/min; 1,250 cm³/min), and most preferably, less than or equal to 0.25 SCFM (1.32 ft³/min; 625 cm³/min).

The convective flow approach for quantifying substantial isolation/control will often be less practical than the other measures. In general, the reduction in the level of platinum-group condensate defects in glass sheets resulting from use of the limited-volume, gas-filled space is the most practical measure of substantial isolation/control of the space, followed in order by the average oxygen content in the space, the maximum temperature difference within the space, the gas exchange time for the space, and then the maximum linear velocity and overall flowrate values due to convective flows in the space. In certain embodiments of the invention, only one of the foregoing measures of substantial isolation/control will be satisfied, although in certain preferred embodiments, multiple measures (including all the measures) are satisfied.

The substantially-isolated/controlled, limited-volume, gas-filled space of the invention can be used at various locations in the glass making process where flowing molten glass has a free surface and one or more structures which comprise platinum-group metals which can serve as a source for condensate defects are located at or above the free surface. FIG. 7 is a schematic diagram of a sheet glass manufacturing line employing the fusion process. It is to be understood that the fusion process has been selected only for purposes of illustration and that the invention is applicable generally to all types of sheet glass manufacturing processes, e.g., slot draw and float processes.

As shown in FIG. 7, raw materials 114 are melted in melter 110 and then proceed through finer 115, stir chamber 120 equipped with stirrer 121, and bowl 127 to the inlet 132 of isopipe 133 which forms a ribbon of glass which is divided into individual glass sheets 137, which after suitable finishing can be used as substrates in the production of, for example, liquid crystal and other types of displays. Preferably, the finer, stir chamber, bowl and their connecting conduits are contained in a capsule 142 which provides a controlled environment around these components designed to reduce the occurrence of gaseous inclusions in glass sheets 137 as a result of hydrogen permeation through the platinum-containing walls of these vessels. See U.S. Patent Publication No. US 2006/0242996, the contents of which in their entirety are incorporated herein by reference.

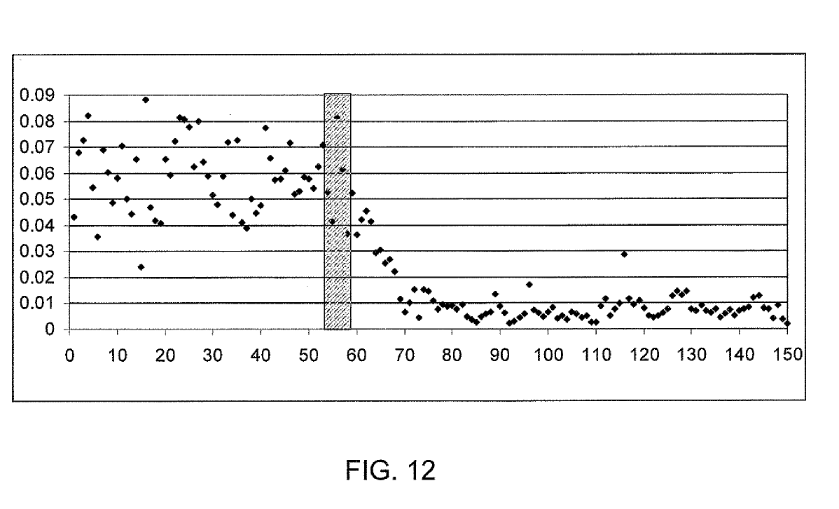

Dashed line 116 in FIG. 7 represents the glass line of the system and as can be seen, the glass line constitutes a free surface in finer 115, stir chamber 120, and bowl 127. In addition, a free surface is also formed at the transition from the delivery portion of the system to the forming portion of the system, e.g., a free surface is formed at the inlet 132 of isopipe 133. Structures comprising platinum-group metals are present at each of these locations and thus each location is a candidate for the application of a substantially-isolated/controlled, limited-volume, gas-filled space in accordance with the invention. FIG. 7 schematically shows such gas-filled spaces at 113a for the finer, 113b for the stir chamber, 113c for the bowl, and 113d for the transition from the delivery system to the fusion machine. The introduction of a gas having a controlled composition, e.g., an oxygen concentration of 10 volume percent or less, into these spaces is also illustrated by arrows 118a, 118b, 118c, and 118d. It should be noted that the gas-filled space within capsule 142, even when it has a low oxygen concentration, is not sufficiently isolated or controlled to avoid the formation of platinum-group condensate defects. In particular, the capsule space exhibits substantial thermal and oxygen gradients, as well as substantial gas flows, all of which lead to platinum-group condensate defects (see, for example, FIGS. 1-4). Indeed, as discussed further below, the data for the time points which precede the vertical bar in FIG. 12 were obtained using a capsule 142 and are plainly much higher than those achieved after the vertical bar where the present invention was employed.

A particularly advantageous application of the invention is at stir chamber 120. FIGS. 8-11 show an embodiment of equipment 300 which can be used to form the desired substantially-isolated/controlled, limited-volume, gas-filled space at and above a stir chamber's free surface of molten glass. Circled area 310 of FIG. 8 shows the equipment in its assembled state ready for attachment to the top of an existing stir chamber to form the desired space. As shown, equipment 300 is supported by superstructure 350 which carries motor assembly 330 for rotating stirrer 340.

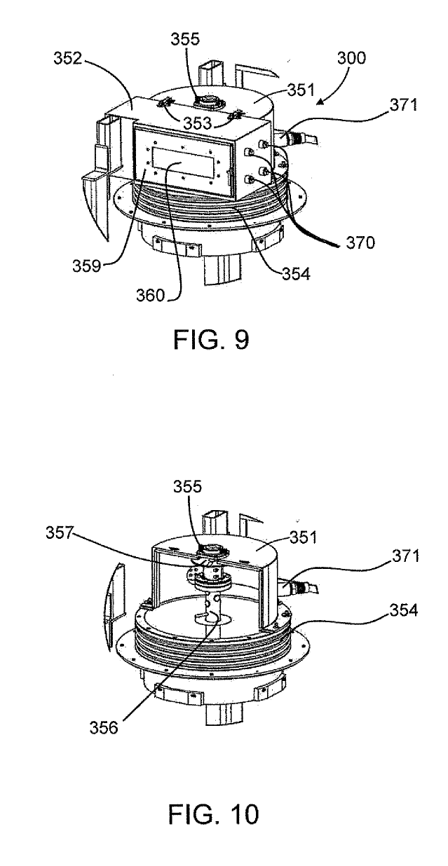

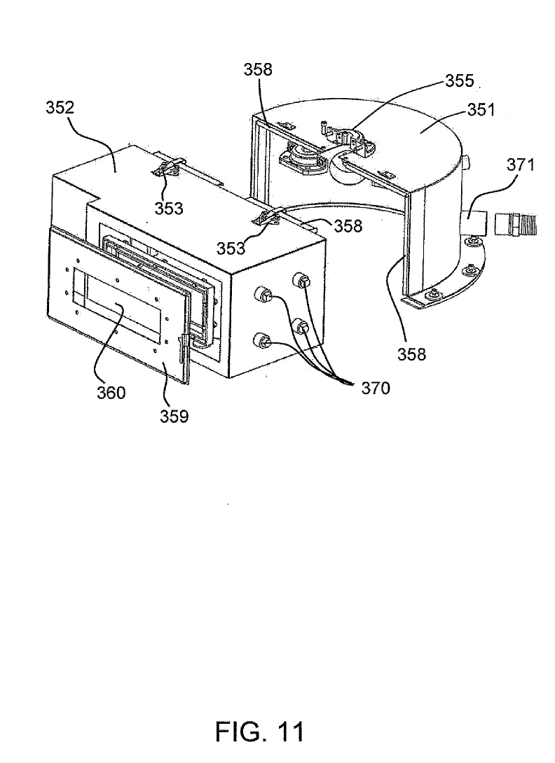

FIGS. 9-11 show equipment 300 in more detail. The apparatus includes rear and front sections 351, 352, which can be made of sheet metal and can be assembled with quick latches 353 which force together high temperature seals 358 (see FIG. 11). Section 351 is bolted to a bellows device 354 which allows the gas-filled space to remain substantially sealed as the equipment is heated from room temperature to its operating temperature. Split bearing assembly 355 provides a seal between the stirrer's shaft 356 and the top of the apparatus. To prevent potential contamination from the bearing assembly, a disk dust collector 357 is located under the bearing and is attached to the stirrer shaft. Multiple electrical isolator gaskets can be employed to avoid unintended grounding of the equipment.

Front section 352 has a latched door 359 to allow access for maintenance of the protected area. The door includes a window 360 made of fire rated glass, which allows viewing of the enclosed space without opening the door and thus destroying the isolation of the gas-filled space. Front and rear sections 351,352 have multiple access ports 370 for pressure control/monitoring, oxygen and dew point sensors, and control/monitoring thermocouples, as well as port 371 for introducing gas of a controlled composition into the gas-filled space. A heat exchanger (not shown) can be included in the apparatus to help regulate the temperature of the gas inside the equipment, as well as to protect temperature sensitive electrical components from overheating.

FIG. 12 shows the effectiveness of the invention in reducing platinum-group condensate defects in sheet glass. The vertical axis in this figure shows platinum defects per pound measured on solidified glass sheets and the horizontal axis is a series of time points over a three week period. The time points are not equally spaced, with different numbers of measurements having been made at different times on different days. At least two measurements were made on each day of the test. Each time point represents four hours of glass sheet production.

The vertical bar between times points 50 and 60 represents the point during the experiment at which substantial control was applied to the oxygen and temperature gradients within a limited-volume, gas-filled space at and above the free surface of molten glass passing through a stir chamber of a glass sheet manufacturing line using the fusion process. This change in operating conditions took place about one week into the experiment.

For the time points before the vertical bar, the oxygen content and temperatures within the space were allowed to vary as a result of changes within the capsule environment (see 142 of FIG. 7) surrounding the lower portion of the stir chamber and the ambient air surrounding the upper portion of the stir chamber. At the vertical bar, the oxygen gradients within the limited-volume, gas-filled space were reduced by sealing the volume from the capsule environment and allowing the internal volume to equilibrate with air outside of the capsule environment through limited flow between the internal volume and the outside air. Because the oxygen content in the capsule was low, i.e., 1.5 vol. %, and the oxygen content in the ambient air was high, i.e., 21 vol. %, substantial gradients existed prior to the vertical bar. By making the oxygen content in the internal volume substantially equal to the oxygen content in the ambient environment, the gradients were minimized. The temperature gradients were also reduced by the sealing of the internal volume from the capsule environment in which there was a steady flow of gas which generated temperature gradients in the space at and above the free surface of the stir chamber.

As can be seen in FIG. 12, the improvement in defect levels achieved by the substantial isolation/control of the oxygen and temperature gradients took place rapidly once the isolation/control was applied, i.e., within a day or so. Although specific calculations were not performed for a space having a configuration identical to that used in the experiment of FIG. 12, from calculations performed on a variety of spaces, the temperature distribution and convective gas flows in the insolated/controlled space would be like those calculated above in connection with FIG. 6 rather than those of FIG. 5.

As can be seen in FIG. 12, the substantially-isolated/controlled, limited-volume, gas-filled space had a profound effect on the defect level in terms of both its average value and its scatter. When the space at and above the free surface of the molten glass passing through the stir chamber was not substantially isolated/controlled, the defect level varied widely and was routinely above 0.05 defects/pound (0.11 defects/kilogram), while with substantial isolation/control, it became narrowly bound in a band having an average value below 0.01 defects/pound (0.02 defects/kilogram). As noted above, from this data, it can be seen that the invention substantially acts as an on/off switch for platinum-group condensate defects.

From the foregoing, it can be seen that the substantially-isolated/controlled, limited-volume, gas-filled space(s) described herein reduces the level of platinum-group condensate defects in glass sheets by at least one and, preferably, all of the following:
(1) reducing the amount of platinum-group metal oxides in the atmosphere at and above a free surface of flowing molten glass by lowering the oxygen content of the atmosphere;
(2) reducing the amount of platinum-group metal oxides in the atmosphere at and above a free surface of flowing molten glass by limiting the movement of the atmosphere to establish more stagnant conditions which will slow the rate of platinum-group metal oxidation and volatilization;
(3) reducing the range of temperatures or temperature gradients in the atmosphere at and above a free surface of flowing molten glass to limit the amount of platinum-group metal oxides that condense and form solids that can become defects (e.g., inclusions) in the solidified glass; and/or
(4) reducing the range of oxygen concentrations or oxygen gradients in the atmosphere at and above a free surface of flowing molten glass to provide a more homogenous gaseous environment and thereby limit the amount of platinum-group metal oxides that condense and form solids that can become defects (e.g., inclusions) in the solidified glass.

Unlike other approaches, this approach addresses and controls both the source(s) and sink(s) of defect generation. It is applicable to all types of display glasses and any glass melted or delivered in a system employing platinum-group metals irrespective of the specifics of the glass' composition. Moreover, as an additional benefit, for glass compositions that contain substantial amounts of volatile oxides, e.g., B and/or Sn oxides, the substantially-isolated/controlled, limited-volume, gas-filled space(s) reduces condensate defects from such oxides as a result of the oxides leaving the molten glass at a free surface, condensing on structures at or above the free surface, and then raining down on the free surface or being entrained in the flowing glass to form additional defects in glass sheets.

Based on the foregoing disclosure, a variety of modifications which do not depart from the scope and spirit of the invention will be evident to persons of ordinary skill in the art. The following claims are intended to cover the specific embodiments set forth herein as well as such modifications, variations, and equivalents.

What is claimed is:

1. A method for reducing the level of platinum-group condensate defects in glass sheets produced by a process in which flowing molten glass has a free surface that is located at or below a structure that comprises a platinum-group metal that can serve as a source of said defects, said method comprising:
(a) providing a limited-volume, gas-filled space which is in contact with said free surface and said structure; and
(b) substantially controlling the environment within the space and substantially isolating the space from the surrounding environment so that the average level of platinum-group condensate defects in the glass sheets produced by the process is less than or equal to 0.02 defects/kilogram.

2. The method of claim 1 wherein the free surface is the free surface of a stir chamber and the structure comprises the wall of the stir chamber.

3. The method of claim 1 wherein the space is filled with a gas whose average oxygen content is less than or equal to 10 volume percent.

4. The method of claim 1 wherein the maximum temperature difference between any two points within the space as determined by computer modeling is less than or equal to 250° C.

5. The method of claim 1 wherein the gas exchange time for the space is greater than 3 minutes.

6. The method of claim 1 wherein the maximum convective linear velocity within the space as determined by computer modeling is less than or equal to 15 centimeters/second.

7. The method of claim 1 wherein the convective flowrate within the space as determined by computer modeling is less than or equal to 1 standard cubic feet per minute.

8. A method for reducing the level of platinum-group condensate defects in glass sheets produced by a process in which flowing molten glass has a free surface that is located at or below a structure that comprises a platinum-group metal that can serve as a source of said defects, said method comprising:
(a) providing a limited-volume, gas-filled space which is in contact with said free surface and said structure; and
(b) substantially controlling the environment within the space and substantially isolating the space from the surrounding environment so as to produce an average level of platinum-group condensate defects in the glass sheets produced by the process that is at least 50% less than the average level of platinum-group condensate defects in glass sheets produced by the same process but without the substantial control and isolation.

9. The method of claim 8 wherein the free surface is the free surface of a stir chamber and the structure comprises the wall of the stir chamber.

10. The method of claim 8 wherein the space is filled with a gas whose average oxygen content is less than or equal to 10 volume percent.

11. The method of claim 8 wherein the maximum temperature difference between any two points within the space as determined by computer modeling is less than or equal to 250° C.

12. The method of claim 8 wherein the gas exchange time for the space is greater than 3 minutes.

13. The method of claim 8 wherein the maximum convective linear velocity within the space as determined by computer modeling is less than or equal to 15 centimeters/second.

14. The method of claim 8 wherein the convective flowrate within the space as determined by computer modeling is less than or equal to 1 standard cubic feet per minute.

15. Apparatus comprising:
(a) an enclosure over a free surface of flowing molten glass, said enclosure having a limited internal volume, said volume being in contact with a material which comprises a platinum-group metal;
(b) at least one heat source which provides heat to the enclosure; and
(c) at least one inlet through which gas of a defined composition is introduced into the enclosure at a selected rate;
wherein:
(i) the maximum temperature difference between any two points within the enclosure is less than or equal to 250° C.; and
(ii) the selected rate results in a gas exchange time for the enclosure which is greater than 3 minutes.

16. The apparatus of claim 15 wherein the maximum temperature difference is determined by computer modeling.

17. The apparatus of claim 15 wherein the enclosure is over the free surface of a stir chamber.

18. The apparatus of claim 15 wherein the gas' average oxygen content is less than or equal to 10 volume percent.

19. The apparatus of claim 15 wherein the difference between the pressure of the gas within the enclosure and the ambient pressure adjacent to the outside of the enclosure is greater than zero and less than or equal to 0.01 atmospheres.

20. A population of 100 sequential glass sheets produced by a glass sheet manufacturing process wherein: (i) each sheet has a volume of at least 1,800 cubic centimeters, and (ii) the level of platinum-group condensate defects for the population is less than or equal to 0.02 defects/kilogram.

21. The population of claim 20 wherein the glass sheets are produced by an overflow downdraw manufacturing process.
